(19) United States
(12) Patent Application Publication
(10) Pub. No.: US 2010/0317521 A1
(43) Pub. Date: Dec. 16, 2010

(54) Herbicide consisting of a glyphosate formulation containing as a surfactant an alkylamine polyethoxylated where the alkyl group is branched in order to reduce substancially the surface tension and improve efficacy

(76) Inventor: Pedro Brito Correia, (US)

Correspondence Address: Pedro Brito Correia, Rua Prof Egas Moniz 11, Estoril, 2765 218, omitted

(21) Appl. No.: 12/484,212

(22) Filed: Jun. 14, 2009

(51) Int. Cl. A01N 57/20; A01P 13/00

(52) U.S. Cl. 504/206

(57) ABSTRACT

Linear Alkyl amine polyethoxylated containing in the alkyl chain 16 to 20 carbon atoms are well known surfactants for glyphosate formulations, which have synergistic effects, besides the reduction of surface tension.

Concerns on environment and health negative effects of these surfactants forced the search to new compounds.

Branched alkyl alcohol polyethoxylated with alkyl chains with less carbon atoms like 10-12 have been earlier used together with the linear alkylamine polyethoxylated in order to reduce the micelle formation and therefore the surface tension. In this way the content of the classical long chain alkylamines polyethoxylated could be reduced.

Branches in the alkyl chain create steric hindrance to micelle formation. Micelles consisting of surfactant molecules reduce the amount of surfactant available to decrease the surface tension.

Because of miscibility limitations, the content of the branched alcohol polyethoxylated is limited.

We found that a branched alkyl amine polyethoxylated mixed or not with a branched alkyl alcohol polyethoxylated makes possible a reduction of isopropylamine, which is a co-formulant, and avoids the micelle formation, which is the most important. The speed of penetration of the solution in water of the glyphosate formulation through the membranes of the leaves of the weeds is therefore strongly improved, therefore improving the efficacy as an herbicide.

### FIELD OF INVENTION

Herbicides, Glyphosate formulations, Surfactants

### BACKGROUND OF THE INVENTION

Important concerns on health and environment exist worldwide on the consequences of the application of herbicides and other pesticides for food production.

The need to strongly increase the yields per hectar and the quality of food are important factors influencing the use of pesticides, mainly considering the problems of hunger.

In order to find a compromise between these two opposite factors, the European Commission improved directive 91/414, the US Government improved FIFRA, and FAO and the World Health Organisation are preparing a Guideline on the Use of Pesticides to be approved by all countries,

The objective is to harmonize the rules on the sales authorization of pesticides.

It is unacceptable that the World Trade Organisation creates a free market, if food originated in some countries are exported to other countries, where the residues of pesticides in the food do not comply with existing rules in the importing countries.

Since glyphosate was patented by the US company Monsanto, alkylamine polyethoxylated as surfactants were included in the first patents.

The length of the linear alkyl chain was subject to optimising efforts, the use of other surfactants to be mixed with alkylamine polyethoxylated was also tried, the use of other families of compounds like alkylphosphonates polyethoxylated, polysiloxanes, sarcosinates, betain polyethoxylates and many other compounds have been patented.

Glyphosate is by far the most sold pesticide worldwide, and its production volumes were even increased by the introduction in many countries of the genetic modified seeds resistant to glyphosate.

A surfactant for such high volume herbicide has to present a high performance and availability but must have a low cost.

A good surfactant allows a reduction of the dose per hectar, and improves the speed of absorption of the water solution of the glyphosate formulation by the leaves of the weeds. This makes possible the application of glyphosate under rainy weather conditions.

In fact, if it rains a shorter time after the application of the herbicide, there will be no more herbicide on the leaves, because it was absorbed.

### DETAILED DESCRIPTION OF THE INVENTION

It is well known from surfactant chemistry that the surfactant molecules act by making a monolayer around the particle to be dispersed or emulsified in water.

A surfactant molecule consists of a lipophilic part attracted by the particle to be emulsified and a hydrophilic part which is oriented in the opposite direction.

The surfactant orients itself on the water surface with the lipophilic part of the molecules oriented to the air, and the hydrophilic part directed to the center of the water drop. The surfactant builds like a fat thin layer on the water surface.

Based on this mechanism it is possible to reduce the size of droplets by spaying a water solution of an herbicide. Besides this effect, the droplets in contact to the surface of the leaves are not spheric and fall to ground but are spread in the surface of the leaves, because the attraction of the solution molecules to the leaves is bigger than the attraction of the molecules of the solution among themselves.

Some surfactant molecules have the tendency to come together in clusters building micelles, instead of going apart from each other and increasing the interaction with the solvent and reducing its surface tension.

The formation of micelles reduces the amount of surfactant available to reduce the surface tension.

On the other side, glyphosate is an aminoacide, therefore presenting an amphoteric character, and an isoelectric point in water solutions. The solubility of glyphosate is only 1.5% at room temperature and the pH of this solution of around 2%. In order to increase the solubility it is necessary to increase the pH by adding an alkaline hydroxyde or an amine.

It was found that the addition of an amine increases the miscibility with the surfactant. However, the amine has itself and alone no herbicide action and is therefore a polutant.

Using a surfactant containing an amine makes possible to reduce the content of the amine, which anyhow is used exclusively to increase the pH.

A longer chain of the alkyl group of the surfactant normally reduces its biodegradability and increases its toxicity.

Alkyl groups like propyl heptyl present a favourable behavior in the daphnia test, in the test of algal growth inhibition, and in biodegradability, as compared to C16-C18 alkyl groups from natural fat.

According to our Portuguese Patent 2005/103372, we presented a formulation containing a mixture of branched or even cyclised alkyl groups as alcohol polyethoxylated mixed with long chain alkyl amines polyethoxylated.

We propose now to use the branched alkyl groups in the amine polyethoxylated itself.

Another fundamental improvement made possible by this surfactant is the possibility to use a concentration of 450 g/liter of glyphosate or even higher, which reduces the cost and recycling of packages.

It is also possible to evaporate most of the water content of the solution in order to make a powder.

### EXAMPLE

We mix following quantities in a stirred reactor with 1.5 liters:

| | | |
|---|---|---|
| Water | 445 | g |
| Propylheptylamine polyethoxylated | 150 | g |
| After the solution was prepared, we add | 475 | g |
| Glyphosate 95% technical grade | | |
| Isopropylamine | 130 | g |
| Total | 1200 | g/liter |

After total solution we measured the surface tension by the ring method of a 1% water solution and found 17 mN/m. This is a better surface tension than the typical value of 25-32 mN/m.

Field trials are underway.

### BIBLIOGRAPHY

1. Portuguese Patent 2005/103372

2. U.S. Pat. No. 5,258,359

3. U.S. Pat. No. 5,658,853

4. U.S. Pat. No. 5,663,117

5. U.S. Pat. No. 5,912,209

6. U.S. Pat. No. 6,734,141

7. EU Patent 1 541 023

1. An herbicide consisting of a glyphosate formulation containing as a surfactant an alkylamine polyethoxylated where the alkyl group is branched in order to reduce substantially the surface tension and improve efficacy

2. In the product of claim 1 where the alkyl group contains 6-14 carbon atoms which are not linear and may therefore include methyl, ethyl, propyl, butyl side groups

3. In the product of claim 1 where in the structure of the alkyl chain is included as main structure or side structure a cyclohexyl group

4. In the product of claim 1 where the number of ethylene oxide monomers of the polyethoxylated chain are 2 to 20 preferably 5 to 10

5. In the product of claim 1 where the amine atom may be bound to one or two alkyl chains, where the third valence is connected to the polyethoxylated chain

6. In the product of claim 1 where the pH is increased above the isoelectric point by adding an alkaline metal hydroxide, or isopropylamine

7. In the product of claim 1 where the water of the solution containing glyphosate, isopropyl amine or alkaline hydroxide and surfactant is evaporated so as to convert the formulation in a powder.
